(19) United States
(12) Patent Application Publication
(10) Pub. No.: US 2015/0144309 A1
(43) Pub. Date: May 28, 2015

(54) Flattened Envelope Heat Exchanger

(71) Applicant: Brayton Energy, LLC, Hampton, NH (US)

(72) Inventor: James S. Nash, North Hampton, NH (US)

(21) Appl. No.: 14/555,215

(22) Filed: Nov. 26, 2014

Related U.S. Application Data
(60) Provisional application No. 61/909,492, filed on Nov. 27, 2013.

(51) Int. Cl. F28F 3/04; B23P 15/26

(52) U.S. Cl. CPC F28F 3/04; B23P 15/26
USPC 165/133; 165/170; 29/890.03

(57) ABSTRACT

The present invention provides an apparatus and method for heat exchange. Embodiments of the present invention include a method and apparatus for heat exchange employing a unit cell using interior and exterior fins, the interior fins disposed within a flattened envelope structure. In one particular embodiment, the heat exchanger is directed for use as a gas engine recuperator.

### CROSS REFERENCE TO RELATED APPLICATIONS

This application claims the benefit of U.S. Provisional Patent Application No. 61/909,492 entitled “Flattened Envelope Heat Exchanger” filed on Nov. 27, 2014, the entire disclosure of which is incorporated by reference herein. This application cross-references U.S. Provisional Patent Application Nos. 61/778,742 filed Mar. 13, 2013, and 61/809,931 filed Apr. 9, 2013.

### FIELD

Embodiments of the present invention are generally related to a method and apparatus for heat exchange, and in particular, to a method and apparatus for heat exchange employing a unit cell using interior and exterior fins, the interior fins disposed within a flattened envelope structure. In one particular embodiment, the heat exchanger is directed for use as a gas engine recuperator.

### BACKGROUND

The recuperation of the gas turbine engine is a proven method for increasing thermal efficiency. However, technical challenges associated with surviving the severe environment of a gas turbine exhaust while meeting the equally severe cost challenges has limited the number of viable products. A gas turbine recuperator is typically exposed to a thermal gradient of up to 600° C., pressures of 3 to 22 bar, and may operate at a gas temperature of over 700° C. Moreover, developers of advanced recuperated gas turbine systems are considering applications with pressures of up to 300 bar and temperatures ranging to 1000° C.

The successful design must tolerate severe thermal gradients, and repeated thermal cycling, by allowing unrestricted thermal strain. The structural requirements to manage very high pressures tend to work against the normal design preferences for structural flexibility, which is important to tolerating large and rapid thermal transients. Often the thermal-strain tolerant heat exchanger core requires a case and internal structures to manage the internal pressure loads. In one aspect, the subject disclosure is directed to a heat exchange device and system using a flattened profile tube as the pressure boundary.

### SUMMARY

It is one aspect of the present invention to provide a method and apparatus for heat exchange, and in particular, to a method and apparatus for heat exchange employing a unit cell using interior and exterior fins, the interior fins disposed within a flattened envelope structure. In one particular embodiment, the heat exchanger is directed for use as a gas engine recuperator.

The heat exchanger disclosed is created from a stack of unit cells, each joined to a common manifold pipe. The cells have an interior fin member bonded within a thin-walled flattened envelope and a separate fin bonded to the two outer surfaces of the envelope. The internal fin is bonded to the inside of said envelope, providing structural integrity for the cell, while serving as a conduit for a first fluid. The external fins are bonded symmetrically to the exterior surface of said envelope, providing enhanced heat transfer for a second fluid. The term fin may refer to a folded or formed sheet or a woven wire matrix. Said first and second fluids are normally at different pressures, whereas said interior fins may be in compression if said first fluid is at a relatively low pressure, or in tension if said first fluid is at a relatively high pressure. A unit cell is composed of said flattened envelope, a first fin, affixed to the interior surfaces of said cell, a second and third fin member the outer two faces of said envelope. Said envelope of said cell contains an opening at both ends. A heat exchanger is composed of one of more of said cells, stacked upon one another, with said openings welded into a common manifold.

In one embodiment of the invention, a unit cell device for a heat exchanger is disclosed, the device comprising: a peripheral envelope comprising a length, a width, a height, an interior surface, an upper and a lower exterior surface, a first end and a second end, the peripheral envelope forming an interior void defined by the interior surface, the first end and the second end; an interior fin comprising a length, a width, and a height, the interior fin disposed with the interior void and interconnected to the interior surface, the interior fin forming a plurality of longitudinal cavities; a first exterior fin disposed on the upper exterior surface; and a second exterior fin disposed on the lower exterior surface.

In some embodiments, additional features of the device comprise: the interior fin length is less than the peripheral length, each of the first exterior fin and the second exterior fin form a plurality of longitudinal cavities, the upper and the lower exterior surfaces are parallel and planar, the interior fin is interconnected to at least one of an upper interior surface and a lower interior surface of the peripheral envelope, the interior fin is interconnected to both an upper interior surface and a lower interior surface of the peripheral envelope, the interior fin is interconnected to at least one of an upper interior surface and a lower interior surface of the peripheral envelope by at least one of brazing, soldering and diffusion bonding, the upper and the lower exterior surfaces are interconnected by rounded edges defining the height of the peripheral envelope, the interior fin is configured in a sinusoidal cross-sectional shape forming the plurality of longitudinal cavities, the interior fin is coated with at least one of a braze alloy or a metal melt depressant slurry, the first manifold interconnects to a plurality of unit cell devices, the plurality of unit cell devices stacked upon one another, each of the first exterior fin and the second exterior fin form a plurality of longitudinal cavities, wherein the upper and the lower exterior surfaces are parallel and planar, wherein each of the interior fin and exterior fins are of sinusoidal cross-sectional shape, the device further comprises a first manifold, the first manifold configured to provide a first fluid flow with the interior void and interconnected to the first end, and the device further comprises a second manifold, the second manifold connected to the second end.

In another embodiment of the invention, a method of manufacturing a unit cell device for a heat exchanger is disclosed, the method comprising: producing a continuous metal peripheral envelope comprising a length, a width, a height, an interior surface, an upper and a lower exterior surface, a first end and a second end, the peripheral envelope forming an interior void defined by the interior surface, the first end and the second end; providing an interior fin comprising a length, a width, and a height, the interior fin disposed with the interior void, the interior fin forming a plurality of longitudinal cavities; providing a first exterior fin; providing a second exterior fin; inserting the interior fin within the interior void; interconnecting the interior fin to the interior surface; disposing the first exterior fin on the upper exterior surface; and disposing the second exterior fin on the lower exterior surface.

In some embodiments, additional features of the method of manufacturing comprise: the interior fin is interconnected to at least one of an upper interior surface and a lower interior surface of the peripheral envelope by at least one of brazing, the continuous metal peripheral envelope is produced by at least one of drawing or extruding a thick-walled tube into a substantially flattened thin-walled shape, the interior fin is configured in a sinusoidal cross-sectional shape forming the plurality of longitudinal cavities, each of the first exterior fin and the second exterior fin form a plurality of longitudinal cavities, wherein the upper and the lower exterior surfaces are parallel and planar, wherein each of the interior fin and exterior fins are of sinusoidal cross-sectional shape, and the method further comprising the step of soldering and diffusion bonding, coating the interior fin with at least one of a braze alloy or a metal melt depressant slurry.

The term “fin” and variations thereof, as used herein, refers to a folded or formed sheet or a woven wire matrix.

This Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention, and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the Detailed Description of the Invention, the drawing figures, and the exemplary claim set forth herein, taken in conjunction with this Summary of the Invention, define the invention.

### BRIEF DESCRIPTION OF THE DRAWINGS

The accompanying drawings, which are incorporated in and constitute a part of the specification, illustrate embodiments of the invention and together with the general description of the invention given above, and the detailed description of the drawings given below, serve to explain the principals of this invention.

FIG. 1 depicts a front elevation view of a portion of a unit cell according to one embodiment of the invention;

FIG. 2 depicts a front elevation view of a complete unit cell of FIG. 1 according to one embodiment of the invention;

FIG. 3 depicts close-up isometric view of a portion of a unit cell of FIG. 1;

FIG. 4 depicts an isometric view of a complete unit cell of FIG. 2;

FIGS. 5-9 depict a unit cell engaged with a manifold according to various embodiments of the invention;

FIGS. 10-11 depict an exploded view of a complete unit cell according to one embodiment of the invention;

FIGS. 12-14 depict a plurality of stacked unit cells engaged with a manifold according to one embodiment of the invention;

FIGS. 15-16 depict portions of a unit cell according to one embodiment of the invention;

FIGS. 17-19 depict method of manufacturing features; and

FIGS. 20-21 depict further embodiments of the disclosed invention.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

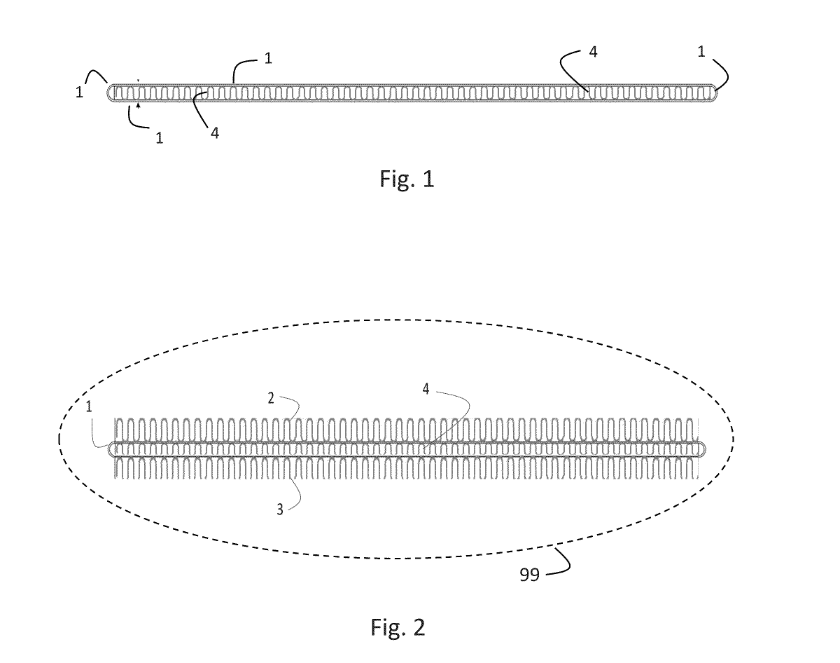

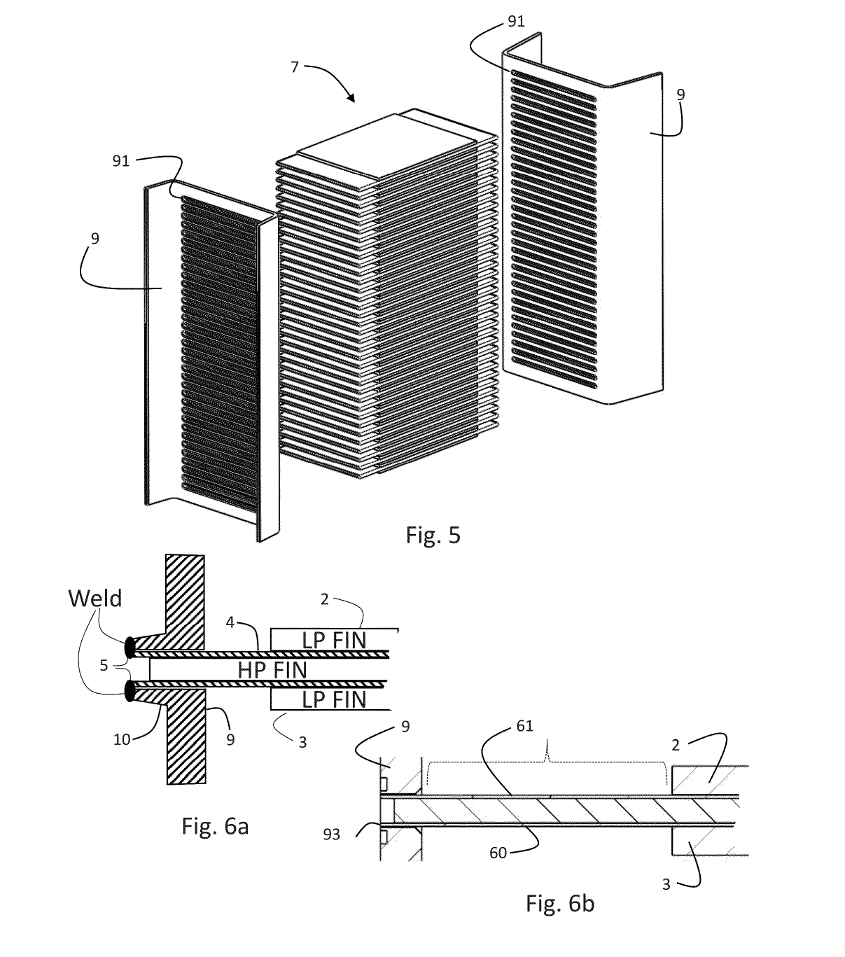

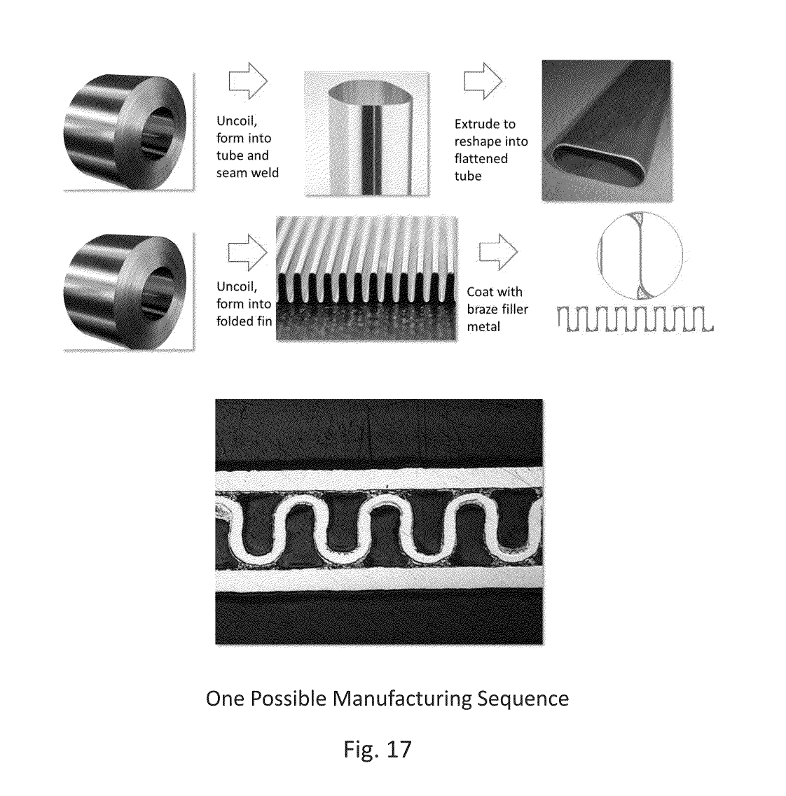

Generally, embodiments of the unit cell are provided in FIGS. 1-4, 10-11, 15-16, and 20-21. Embodiments of the unit cell as engaged with a manifold are provided in FIGS. 5-9 and 12-14. FIGS. 17-19 depict method of manufacturing features.

With respect to FIGS. 1-21, a unit cell 99 comprises an envelope 1, an interior or internal fin 4, an upper or first external fin 2 and a lower or second exterior fin 3. FIG. 1 provides an illustration of the flattened envelope 1 in cross-sectional view. The envelope's perimeter is a continuous sheet. The flattened envelope forms a closed interior volume or void, with exposed first (top), second (bottom) exterior surfaces, and a third (top) interior surface, and a fourth (bottom) exterior surface. Internal fin 4 is sandwiched between the third and fourth interior surfaces and bonded to the interior surfaces by any of several methods known to those skilled in the art, to include brazing, diffusion bonding, soldering, sintered, or otherwise chemical or metallurgical fusion. FIG. 2 illustrates the envelope shown in FIG. 1, with upper or first external fin 2 and a lower or second exterior fin 3 disposed on exterior surfaces of the envelope 1. The fins disclosed comprise a corrugated repeatedly folded segment of sheet metal, a woven wire matrix, porous media, or any other high surface area matrix. A heat exchanger composed of the envelope 1 and interior fin 4 may be configured for duty with or without the exterior heat exchange fin elements 2 and 3.

The envelope shown on FIG. 2 also contains an opening or aperture at a first end, 15 and a second end 16, such that a first fluid may flow from the first to the second end, passing through the fin of tortuous heat exchange matrix.

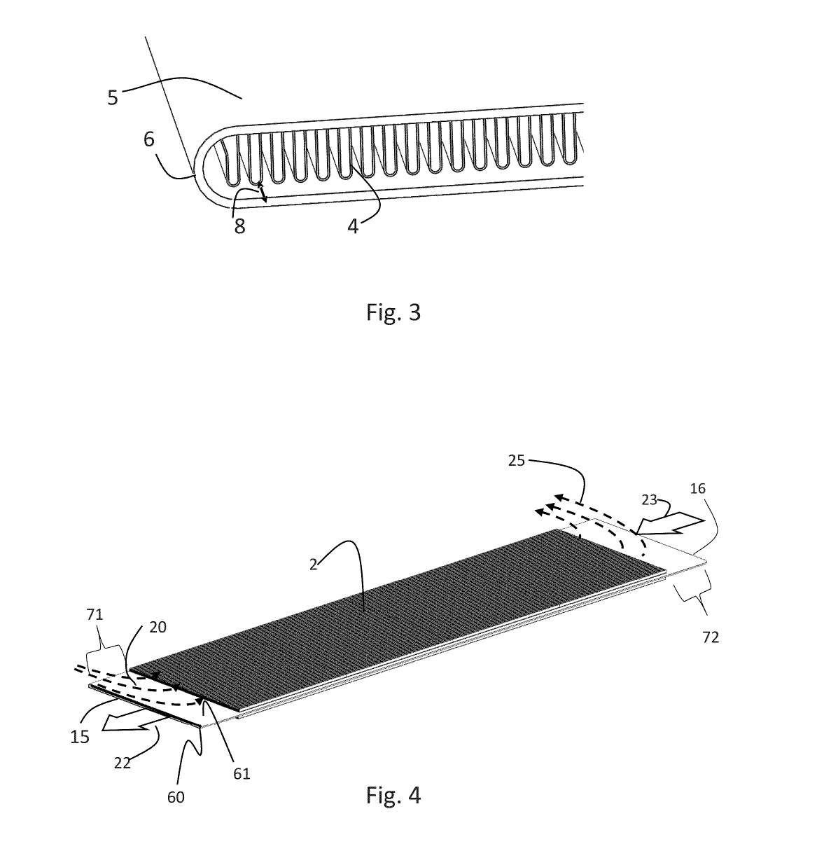

In the example of FIG. 3, the envelope 1 is formed from a seamless or welded tube, flattened or die-formed to have a substantially flat surface 5, with substantially rounded edges 6. The interior fin 4 resides within the envelopes 1 volume or void. The fin segment 4 is recessed to form an over-hanging lip 8 on the envelope. This lip is critical zone of virgin sheet material, later welded into a manifold. In one embodiment, the interior fin 4 engages a relatively higher pressure first fluid, as is dubbed an HP (high pressure) fin.

FIG. 2 identifies the internal fin 4, with first external fin 2 (top) and second external fin 3 (bottom), bonded to flattened tube envelope 1. The entire unit cell 99 is composed of flattened tube 1 with fins 2, 3, 4 bonded to the envelope 1. The term bonded includes, but is not limited to, brazing, diffusion bonding, sintering, metallurgical joining, ceramic-to ceramic bonding compounds, gluing, or other method used in the field of bonding industrial materials. The term fin relates to a folded or roll-formed sheet, corrugated sheet, folded wavy sheet, woven or sintered wire matrix, or foam or porous matrix, or any extended surface employed in the heat transfer industry. In one embodiment, one or more fins 2, 3 and 4 are of sinusoidal cross-section (see, e.g., FIG. 16). The bonding of flat envelope 1, first internal fin 4, and first and second external fin elements 2, 3 is hereafter referred to as a unit cell 99.

An isometric view of the opening 15 of the unit cell 99 is shown in FIG. 3. In this view, the flattened envelope 1 is shown to extend beyond the end of fin element 4. This creates a lip or land 8 where no fin is bonded to the envelope. The length of this extended land or lip 8 is typically one to three times the height of the fin 4. The unit cell lips 8 of stacked unit cells 7 may be employed to engage with a manifold, such as slot opening 91 (see, e.g. FIG. 5) allowing the welder to melt the overhanging edge into the slotted plate. The extended lip of said unit-cell is intended to provide isolation between the internal brazed fin, avoiding contamination between the weld and the braze materials. The welding may be automated and performed by laser, TIG, MIG, plasma, or any method common to the art.

An isometric view of the unit cell 99 is shown in FIG. 4 with flow path for a first internal and a second external fluid. The first and second external fin elements 2, 3 are shown to be positioned symmetrically on the first and second external sides of the envelope 1, but not extending the entire length of the envelope 1. On the first end, the external fin stands back from the opening 15 by dimension 71. Likewise, on the second end, the external fin 2 is positioned short of the exit opening 16 by dimension 72. A symmetrical position of fin 3 on the underside of the unit cell 99 is assumed. The second (external) fluid may enter from one side 20 or both sides 20 and 21, through dimension 71. The flow over the non-fined land surface of the envelope 1 is largely normal to the individual conduits formed within the fin passages. After flowing along said land 61 the second fluid turns into the external fin 2, flows through said fin passages bounded by the envelope 1, and exits at the land 62. The second fluid 25 then turns approximately transverse to the fin within the land 62 space and exits the cell trough the opening defined by the dimension 72. The external fluid 25 may exit from one or both sides of the land 72. The aforementioned flow of the second external fluid through fin 2 also occurs on the bottom of the unit cell, through fin element 3 in a symmetrical manner to that described. The first internal fluid 23 flows inside the envelope, entering first opening 16, and exiting second opening 15. The first and second fluids may be arranged to flow typically in opposite directions, or in a so-called counter-flow configuration.

### Manifold Attachment for Unit-Cell Envelope

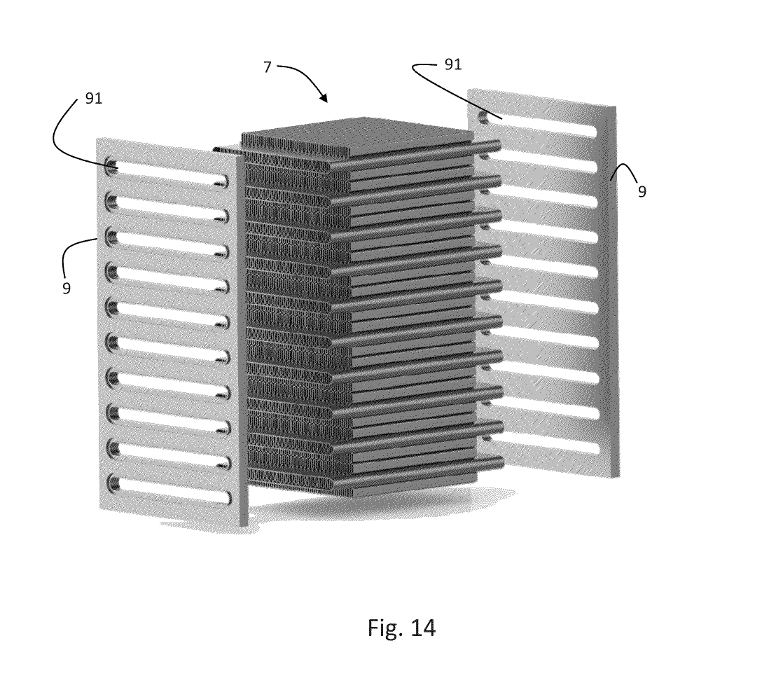

A heat exchanger is created from a plurality of unit cell envelopes 1, i.e. stacked unit cells 7, joined into a common manifold. One manifold option, shown in FIG. 5, is composed of a two slotted plates 9 comprising slot openings 91. The slotted plate 9 may be flat (e.g. FIGS. 5 and 14) or concaved (e.g. FIG. 8).

The slots 91 in said slotted plates 9 have a dimension substantially similar to the cross section of the unit-cell 99, so that the outer dimension of the envelope opening 15 and 16 may slip into the slots.

One method of attachment of the cells to the slotted plate 9 involves welding. For assembly, a unit cell 99 with opening 15 is slipped through the front side of the slotted plate opening 91. As shown in FIG. 6a, the slotted plate may have certain stamped features to facilitate and improve the eventual joining of the envelope 1 to the slotted plate 9. FIG. 6b illustrates one of several optional weld preparation features as known to those skilled in the art of welding. These include embossing, machining, or stamping to create features around the perimeter of the slots of slotted plate 9. The objective of this edge preparation is to thin the edge of the thicker slot plates in the vicinity of the joint with the envelope 1. Approximately matching the thicknesses of the parts to be joined improves the quality of the joint and lowers mechanical stresses.

Alternately, the envelope 1 of the cell 99 may be joined to the slotted plate 9 by brazing or other metallurgical bonding, or by a ceramic gluing method. Using this approach, the extended lip 8 may be reduced in length, as welding into the plate is not required.

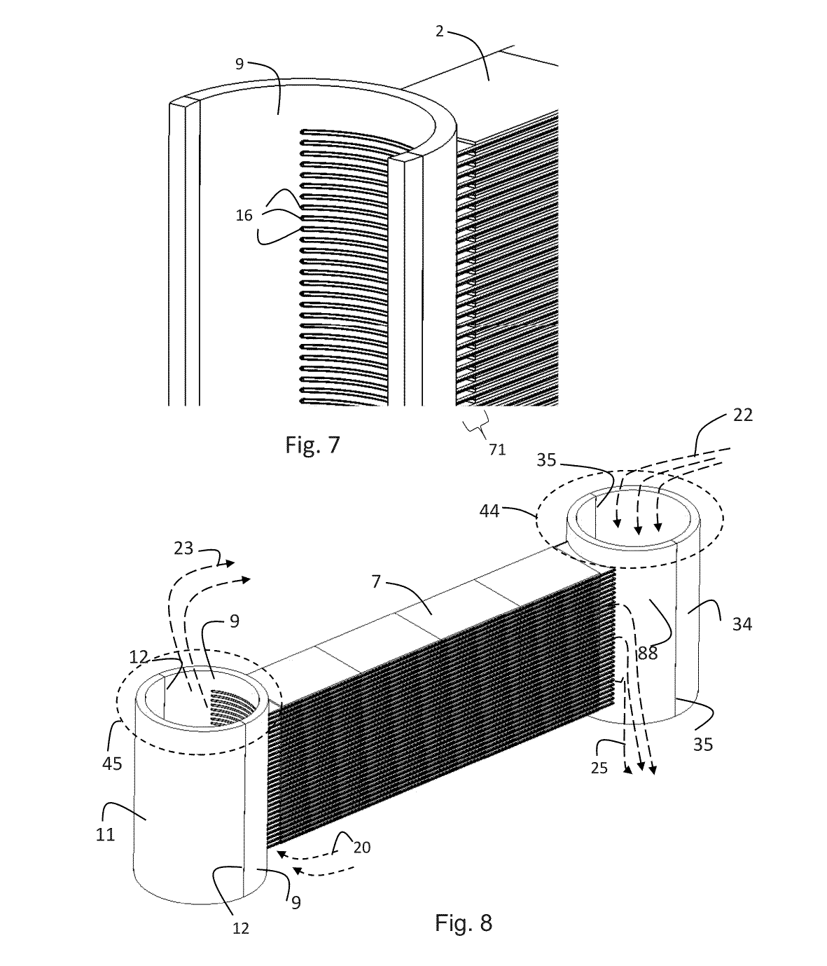

FIG. 7 depicts an alternate embodiment of a slotted plate 9 joining a manifold. In FIG. 7, the slotted plate 9 is substantially circular, and thereby more suitable for applications where the first fluid is as a relatively high pressure. FIG. 8 depicts the flat slotted plate 9 joined to a circular cross-section pipe 11. After the unit cells 99 are inserted and individually welded or brazed into the slotted plate 9, the slotted plate is inserted into the cut-out window and welded along the mating interface 12. A first pipe manifold 44 is created by the closure of the seam 12 between the pipe section 11 and the slotted plate 9. A similar closure of the aft end of the heat exchanger is provided with the welding of the pipe section 34 to slotted plate 9 along weld seem 35, thereby forming a second manifold pipe 45.

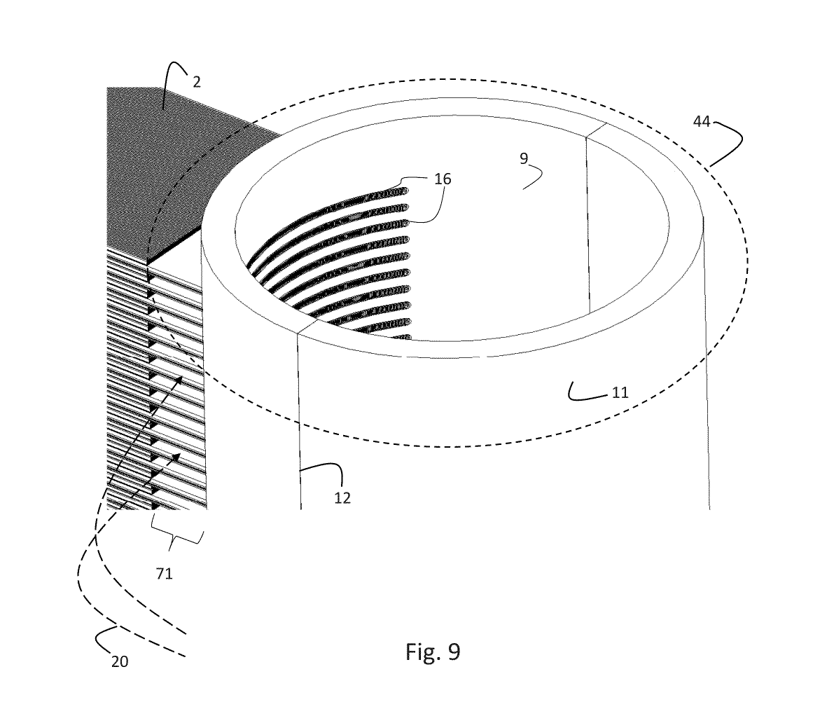

A heat exchanger becomes functional when the first internal fluid enters pipe 44 at either end, or flows through a plurality of unit cell openings 16, along the length of the envelope, and exits into pipe 45 through opening 15. The second fluid exchanges heat with the first fluid by flowing through openings 71 and 72, (FIG. 9) along the length of external fins 2, and 3, and exits through the slots formed by 20 and 21.

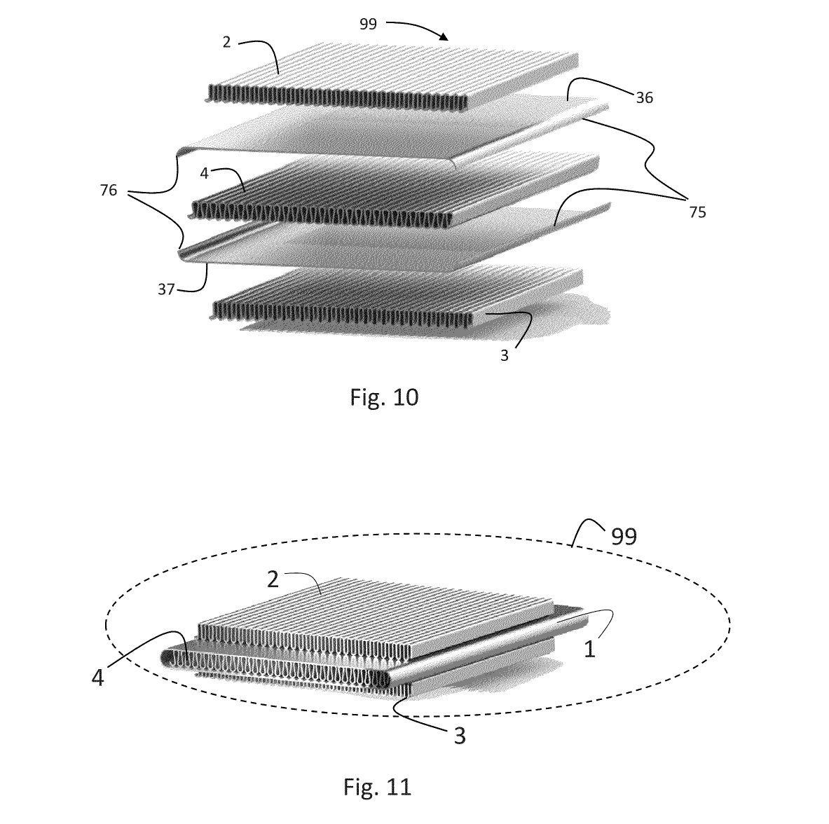

FIG. 10 shows yet another alternative to the unit-cell 99 in exploded view where the continuous envelope 1 is created by welding together two concaved sheets 36 and 37 together at junctions 75 and 76, respectively. In this case, the continuous envelope is created by welding together two mirror image stampings 36, 37 with a substantially dish-shaped flange. Once formed with welded edge at the flange, the internal fin 4 is slipped into the envelope 1. The fin or matrix element may be coated with braze alloy or melt depressant on its upper and lower flat surfaces. The finished unit-cell may receive external fin(s), as required to meet performance requirements. The entire unit cell 99, with continuous welded envelope 1 and coated fin structures may be welded or diffusion bonded by any of several means known to those skilled in the art.

### Heat Exchanger Flow Paths

A heat exchanger is formed by providing a plurality of unit cells 99 into the afore-disclosed slotted plates and manifold pipes. A plurality of envelopes 1 that are welded into slotted manifolds at each end and manifold pipes at each end is commonly referred to as a heat exchanger core. Referring to FIG. 8, the first fluid 22 enters a first pipe manifold 44 at one end of the core and flows into each envelope opening 61 through the fin members 4 along the length of the unit cell envelope 1, discharging into the second manifold pipe 45. A second fluid 20 flows along the exterior fins 2 and 3. Said flow path may be substantially parallel and opposite in direction to the first (internal) fluid, creating counter flow heat exchange.

In yet another embodiment, the external flow may flow cross-wise or substantially orthogonal in direction to the first fluid, creating a cross-flow heat exchange. In yet another embodiment, the second fluid 20 may flow across the envelope, orthogonal to fluid 22, 23 direction, then reverse 180 degrees, and re-enter the exterior fin (matrix)3, 4, creating a multi-pass cross-flow heat exchanger. Baffles and low pressure manifolds may be affixed to the core to facilitate flow configurations comprising counter-flow, cross-flow, and multi-pass cross flow heat exchanger modules.

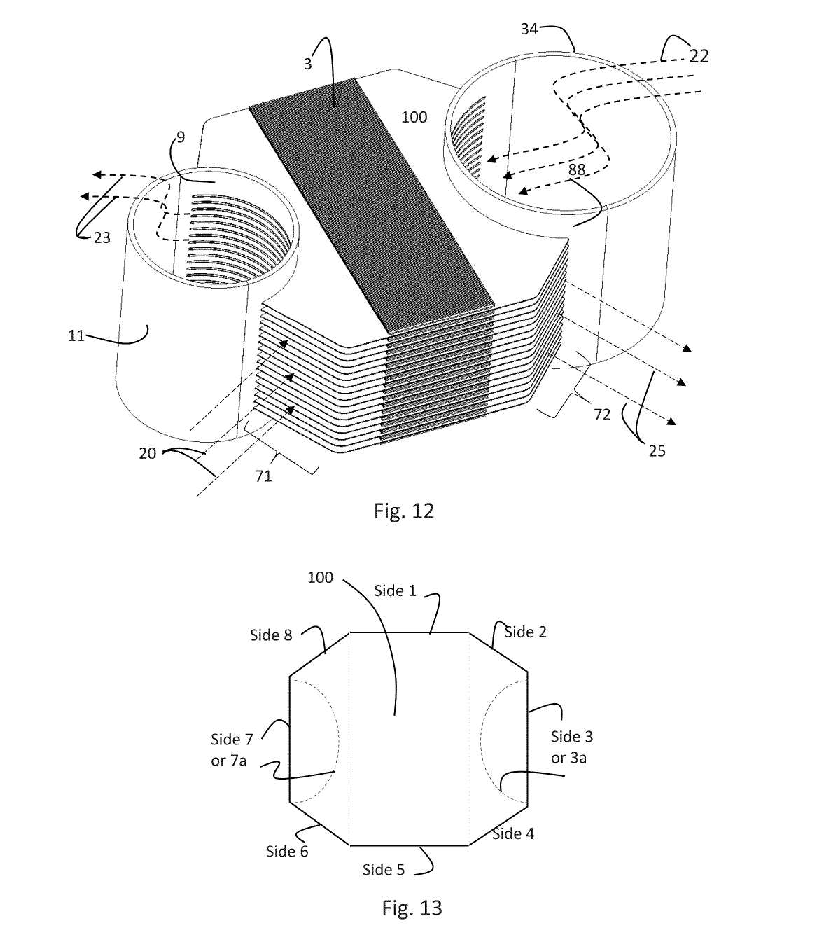

In yet another embodiment, the unit cell 99 geometry incorporates an envelope 1 and fins 2, 3, 4 as shown on FIG. 12. The ‘diamond’ shaped cell allows for increased surface area per cell and lowers cell counts for a given thermal duty requirements. The envelope shape, shown in FIG. 13, is formed by two stamped sheets, each with eight sides (in contrast to the four shown in FIG. 10). As previously described, the unit cell is composed of two stamped sheets, with edge details as described by sheets 36 and 37 in FIG. 10. The eight-sided unit cell is welded into the slotted plate 9. (It is noted that element “slotted plate” 9 may refer to either or both configurations of slotted plate e.g. FIG. 5 and the slotted pipe e.g. FIG. 12). A manifold is created by welding closure pipe 11 to the slotted plate 9 along seam 12. This manifold formation method is then repeated at the aft end, by welding closure pipe section 34 to slotted pipe 88 along seam 35.

The module functions as a heat exchanger with first internal fluid 22 entering the manifold, flowing into the plurality of slot openings 16, entering the envelope, passing through the heat exchange fin 4, exiting slots 15, entering the manifold, and exiting through the pipe. The second external fluid 20 enters the slot 71, flows over the land, and enters fins 2 and 3 of the plurality of cells. The second fluid 20 flows through the heat exchanger fins 2 and 3 the length of the cell, and exits at the slot 72 formed by the stack of cells, and exits at a different temperature shown as 25.

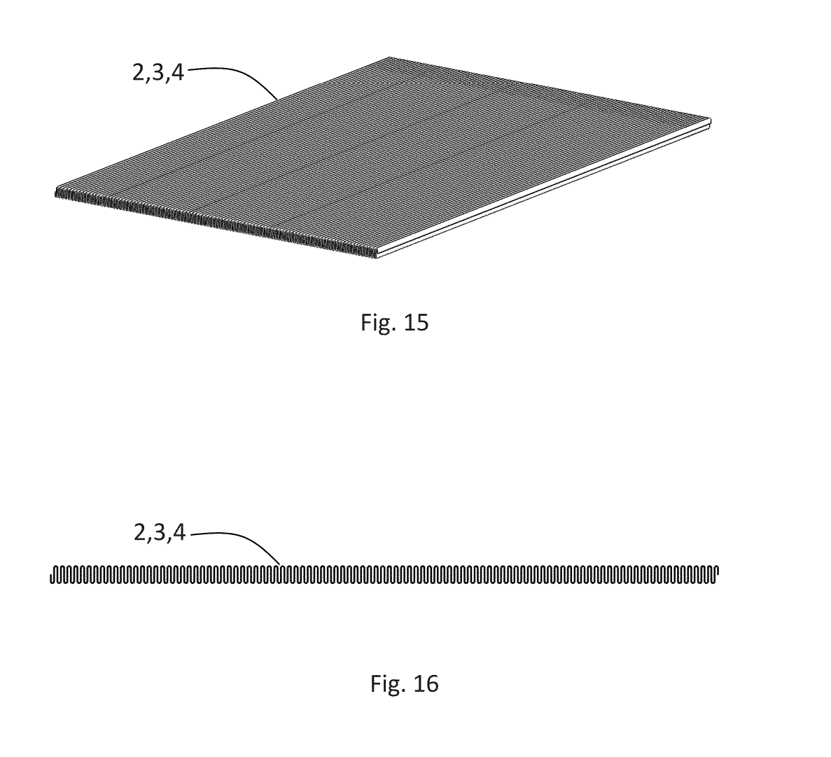

FIG. 14 shows an exploded view of the stack of unit cells, i.e. the stacked unit cells 7, with symmetrical slotted plates 9 with slot openings 91. FIGS. 15 and 16 illustrate fin segments, suitable for any or all of first external fin 2, second external fin 3, and interior fin 4.

FIG. 17 depicts a flowchart showing a method of manufacturing a unit cell as well as the completed unit cell. The flatten tube is manufactured by uncoiling the metal, forming the metal into a tube and seam welding the tube together. The tube is then extruded to reshape it into a flattened tube. The fin is manufactured by uncoiling the metal, forming the metal into the folded fin, and coating the fin with braze filler metal. The prepared fins are then inserted, fixed into position and tack welded to form the unit cell. The unit cell is then fixed to be cycled through furnace brazing.

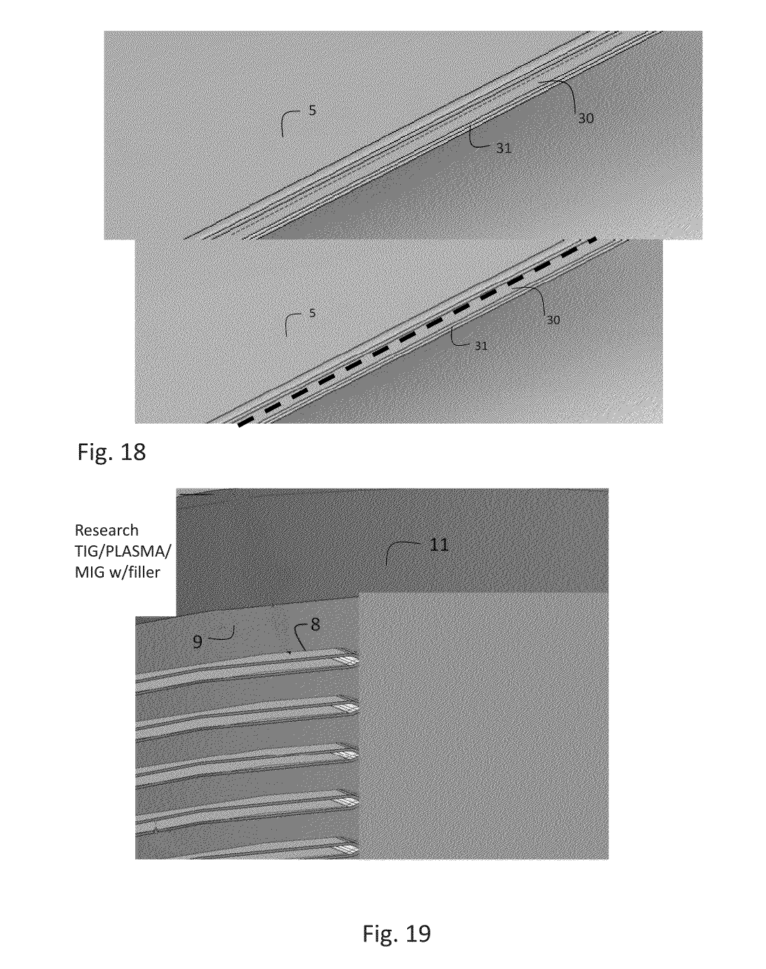

FIG. 18 shows the details of the welded edge, which creates a continuous envelope. This is accomplished by welding two dish-shaped formed plates 5, each mating a flange 30, 31. The autogenous weld may pass through the flange, as is common in laser welding, or fuse the edge in a butt-weld.

FIG. 19 shows unit cells extending through the slotted plate, which are welded or brazed into close-fitting slots.

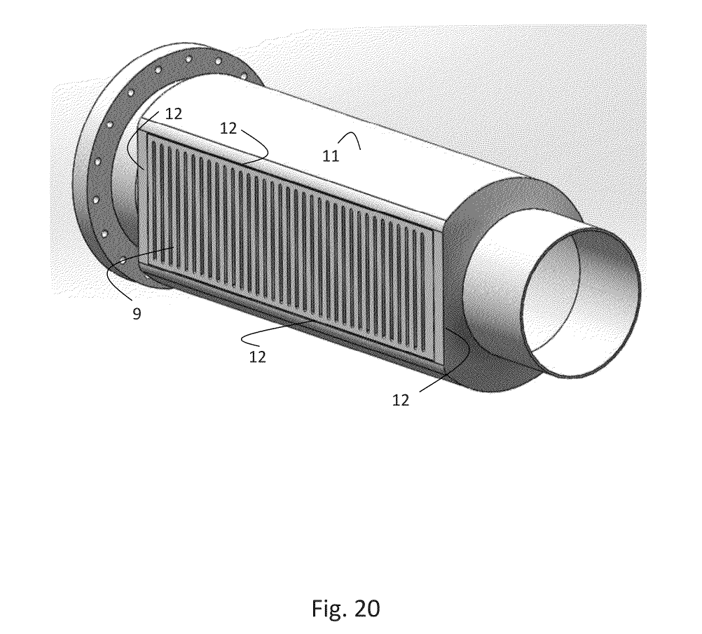

FIG. 20 depicts a typical flat slotted plate, inserted into the cut-out window of the pipe manifold.

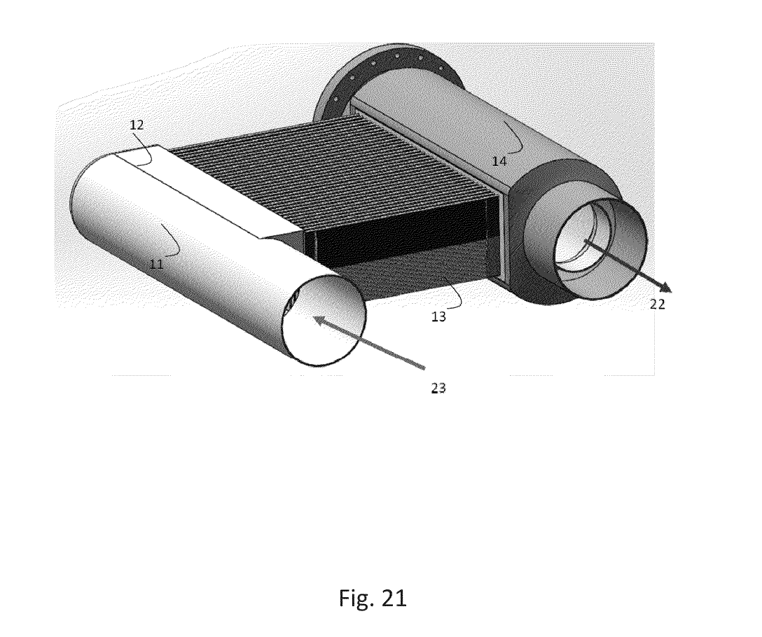

FIG. 21 shows the unit cells 13 stacked into a core, and slotted plates are welded into pipe manifold 11 along the weld interface 12. The manifold pipes collect internal inlet fluid 23 and internal exit fluid 22.

In one embodiment, the a unit cell is composed of the following: a continuous peripheral envelope (flattened tube) with continuous perimeter metal sheet and an interior and exterior surface, and said envelope is a substantially flattened cross section, with a flat top surface, a flat bottom surface, and substantially rounded edges joining said flat top and bottom surfaces, and said envelope having an interior volume, with openings on both ends of a specified length, and a first fin or matrix, with a length, width, and height, is placed on the interior of said envelop, wherein said fin height and width are substantially equal to the interior dimensions of said envelope and length is shorter than that of the envelope length, and said first fin or matrix is roughly centered along the axial length of said envelope, and said metal sheath envelope therefore extends beyond the length of said fin length on both ends, and said first fin or matrix is metallurgically bonded to the interior surface of said envelope. In some embodiments, additional features comprise: said continuous metal perimeter is made by welding the free edges of a flat sheet into a flattened tube; said continuous metal perimeter is made by welding two dish-shaped sheets to one another along a mating flange where: said first stamping is a rectangular shaped sheet, which has a first and second flange along its longer edge, said second stamping is a mirror image of said first sheet, and said first and second stampings are mated along symmetrical flanges, and said welding occurs along the contacting edges of said mating flanges; said continuous metal perimeter is made by drawing or extruding a thick walled tube into substantially flattened thin walled shape; wherein the first fin is metallurgically bonded by brazing, soldering or diffusion bonding to the interior envelope; said first fin or matrix element is coated with braze alloy or a metal melt depressant slurry prior to insertion into said envelope, and prior to said metallurgically bonding operation.

In another embodiment, two or more of said unit-cell assemblies as disclosed above with inter alia flattened envelopes and internal fin are joined together into a heat exchanger composed of the following; a first slotted plate, containing cut-out slots substantially equal to the exterior width and height of said metal envelope, a second slotted plate, containing cut-out slots substantially equal to the exterior width and height of said metal envelope, with said slotted plates having front first surface, and back second surface, with said cut-out slots passing between said first and second surfaces, and said unit-cell assemblies are inserted first through said first surface of said slotted plate during assembly, and where said unit cell protrudes slightly through said second surface, a heat exchanger assembly where a plurality of said unit cell assemblies extend between said first and second slotted plates, passing through said slots on both ends, and said slots are spaced evenly apart by a dimension substantially greater than the height of said unit-cell envelope. Additional features may comprise: said unit-cell is welded to said slotted plate on its second surface, the said unit cell assemblies are welded or brazed or metallurgically bonded to said first and second slotted plates, and span between said first and second slotted plates located at opposite ends of said envelope length, where said first slotted plate, having third, fourth, fifth, and sixth surfaces, or edges, is welded or metallurgically bonded into a four-sided window cut-out in a first pipe, and said second slotted plate, having third, fourth, fifth, and sixth edges and is welded or metallurgically bonded into a window cut-out in a second pipe, an assembly as described composed of an assemblage of said unit cell assemblies, each joined to said first and second slotted plates, where said first slotted plate is welded into a four-sided window cut-out in a first cylindrical pipe and said second slotted plate is welded into a window cut-out of a second cylindrical pipe, where said slotted plates are flat panels, when welded into said cylindrical pipes forms a substantially D-shaped cross-section, where said slotted plates are concaved or convexed; including a second fin or matrix element is braised of metallurgically bonded to the substantially flat outside top surface of said unit-cell envelope assembly; including a third fin or matrix element is braised of metallurgically bonded to the substantially flat outside bottom surface of said unit-cell envelope assembly; where said envelope and said first fin or matrix element is a alumina, mullite, cordierite, silicon carbide, silicon nitride or other ceramic material; where said fin matrix element is a stack of wire screen segments; where said fin is a folded sheet of foil with tightly packed convolutions; and where said slots in said slotted plate incorporate a weld preparation feature.

Regarding FIG. 1, in one embodiment the height is 1.7 mm and the width is 50 mm. The thickness and width may be varied to accommodate a wide range of heat exchanger requirements.

Regarding FIG. 2: The drawing example shows standard folded fin, however wire matrix or other types of rolled, compacted, wavy, or strip fin may be employed.

Regarding FIG. 3: A Unit-cell envelope, or flattened tube with internal fin member, is presented. The internal fin, labeled HP fin, is located within the formed sheet envelope. The envelope extends beyond the fin, to allow for welding or joining to the slotted plate section of the manifold.

To assist in the understanding of the present invention the following list of components and associated numbering found in the drawings is provided herein:

| Reference No. | Component |
|---|---|
| 1 | Envelope |
| 2 | First (upper) external fin |
| 3 | Second (lower) external fin |
| 4 | Interior (internal) fin |
| 5 | Flat surface |
| 6 | Rounded edge |
| 7 | Stacked Unit Cells |
| 8 | Lip |
| 44 | First Pipe Manifold |
| 45 | Second Pipe Manifold |
| 61 | Envelope opening |
| 62 | Land space |
| 91 | Slot openings |
| 99 | Unit cell |

What is claimed is:

1. A unit cell device for a heat exchanger comprising:
a peripheral envelope comprising a length, a width, a height, an interior surface, an upper and a lower exterior surface, a first end and a second end, the peripheral envelope forming an interior void defined by the interior surface, the first end and the second end;
an interior fin comprising a length, a width, and a height, the interior fin disposed with the interior void and interconnected to the interior surface, the interior fin forming a plurality of longitudinal cavities;
a first exterior fin disposed on the upper exterior surface; and
a second exterior fin disposed on the lower exterior surface.

2. The device of claim 1, wherein the interior fin length is less than the peripheral length.

3. The device of claim 1, wherein each of the first exterior fin and the second exterior fin form a plurality of longitudinal cavities.

4. The device of claim 1, wherein the upper and the lower exterior surfaces are parallel and planar.

5. The device of claim 1, wherein the interior fin is interconnected to at least one of an upper interior surface and a lower interior surface of the peripheral envelope.

6. The device of claim 1, wherein the interior fin is interconnected to both an upper interior surface and a lower interior surface of the peripheral envelope.

7. The device of claim 5, wherein the interior fin is interconnected to at least one of an upper interior surface and a lower interior surface of the peripheral envelope by at least one of brazing, soldering and diffusion bonding.

8. The device of claim 4, wherein the upper and the lower exterior surfaces are interconnected by rounded edges defining the height of the peripheral envelope.

9. The device of claim 1, wherein the interior fin is configured in a sinusoidal cross-sectional shape forming the plurality of longitudinal cavities.

10. The device of claim 10, wherein the interior fin is coated with at least one of a braze alloy or a metal melt depressant slurry.

11. The device of claim 1, further comprising a first manifold, the first manifold configured to provide a first fluid flow with the interior void and interconnected to the first end.

12. The device of claim 11, wherein the first manifold interconnects to a plurality of unit cell devices, the plurality of unit cell devices stacked upon one another.

13. The device of claim 12, further comprising a second manifold, the second manifold connected to the second end.

14. The device of claim 1, wherein each of the first exterior fin and the second exterior fin form a plurality of longitudinal cavities, wherein the upper and the lower exterior surfaces are parallel and planar, wherein each of the interior fin and exterior fins are of sinusoidal cross-sectional shape.

15. A method of manufacturing a unit cell device for a heat exchanger comprising:
producing a continuous metal peripheral envelope comprising a length, a width, a height, an interior surface, an upper and a lower exterior surface, a first end and a second end, the peripheral envelope forming an interior void defined by the interior surface, the first end and the second end;
providing an interior fin comprising a length, a width, and a height, the interior fin disposed with the interior void, the interior fin forming a plurality of longitudinal cavities;
providing a first exterior fin;
providing a second exterior fin;
inserting the interior fin within the interior void;
interconnecting the interior fin to the interior surface;
disposing the first exterior fin on the upper exterior surface; and
disposing the second exterior fin on the lower exterior surface.

16. The method of claim 15, wherein the interior fin is interconnected to at least one of an upper interior surface and a lower interior surface of the peripheral envelope by at least one of brazing, soldering and diffusion bonding.

17. The method of claim 15, further comprising coating the interior fin with at least one of a braze alloy or a metal melt depressant slurry.

18. The method of claim 15, wherein the continuous metal peripheral envelope is produced by at least one of drawing or extruding a thick-walled tube into a substantially flattened thin-walled shape.

19. The method of claim 15, wherein the interior fin is configured in a sinusoidal cross-sectional shape forming the plurality of longitudinal cavities.

20. The method of claim 15, wherein each of the first exterior fin and the second exterior fin form a plurality of longitudinal cavities, wherein the upper and the lower exterior surfaces are parallel and planar, wherein each of the interior fin and exterior fins are of sinusoidal cross-sectional shape.
